(19) United States
(12) Patent Application Publication
(10) Pub. No.: US 2020/0184310 A1
(43) Pub. Date: Jun. 11, 2020

(54) APPARATUS AND METHOD FOR DEEP NEURAL NETWORK MODEL PARAMETER REDUCTION USING SPARSITY REGULARIZED FACTORIZED MATRIX

(71) Applicant: ELECTRONICS AND TELECOMMUNICATIONS RESEARCH INSTITUTE, Daejeon (KR)

(72) Inventors: Hoon CHUNG, Daejeon (KR); Jeon Gue PARK, Daejeon (KR); Yun Keun LEE, Daejeon (KR)

(21) Appl. No.: 16/711,317

(22) Filed: Dec. 11, 2019

(30) Foreign Application Priority Data
Dec. 11, 2018 (KR) 10-2018-0159190

(51) Int. Cl. G06N 3/04; G06N 3/08

(52) U.S. Cl. CPC G06N 3/04; G06N 3/084

(57) ABSTRACT

Provided is an apparatus and method for reducing the number of deep neural network model parameters, the apparatus including a memory in which a program for DNN model parameter reduction is stored, and a processor configured to execute the program, wherein the processor represents hidden layers of the model of the DNN using a full-rank decomposed matrix, uses training that is employed with a sparsity constraint for converting a diagonal matrix value to zero, and determines a rank of each of the hidden layers of the model of the DNN according to a degree of the sparsity constraint.

### CROSS-REFERENCE TO RELATED APPLICATION

This application claims priority to and the benefit of Korean Patent Application No. 10-2018-0159190, filed on Dec. 11, 2018, the disclosure of which is incorporated herein by reference in its entirety.

### BACKGROUND

### 1. Field of the Invention

The present invention relates to an apparatus and method for reducing the number of deep neural network model parameters.

### 2. Discussion of Related Art

A deep neural network (DNN) is an artificial neural network (ANN) including multiple hidden layers between an input layer and an output layer.

As a method of reducing the number of model parameters of the DNN according to the related art, a method using a low-dimensional matrix decomposition, such as truncated singular value decomposition (TSVD), has been proposed but it requires model retraining and has a limitation in optimally reducing the rank of each hidden layer.

### SUMMARY OF THE INVENTION

The present invention provides an apparatus and method for reducing the number of model parameters of a deep neural network (DNN) model using a sparsity regularized factorized matrix.

The technical objectives of the present invention are not limited to the above, and other objectives may become apparent to those of ordinary skill in the art based on the following description.

According to one aspect of the present invention, there is provided an apparatus for reducing parameters of a model of a deep neural network (DNN) using a sparsity regularized factorized matrix, the apparatus including a memory in which a program for DNN model parameter reduction is stored, and a processor configured to execute the program, wherein the processor represents hidden layers of the model of the DNN using a full-rank decomposed matrix, uses training that is employed with a sparsity constraint for converting a diagonal matrix value to zero, and determines a rank of each of the hidden layers of the model of the DNN according to a degree of the sparsity constraint.

According to another aspect of the present invention, there is provided a method of reducing parameters of a model of a deep neural network (DNN) using a sparsity regularized factorized matrix, the method including: (a) representing hidden layers of the model of the DNN using a full-rank decomposed matrix; (b) using training that is employed with a sparsity constraint for converting a diagonal matrix value to zero; and (c) determining a rank of each of the hidden layers of the model of the DNN according to a degree of the sparsity constraint.

### BRIEF DESCRIPTION OF THE DRAWINGS

FIG. 1 is a flowchart showing a method using a low dimensional matrix decomposition method according to the related art.

FIG. 2 is a view illustrating a truncated singular value decomposition (TSVD) according to the related art.

FIG. 3 is a view illustrating an apparatus for reducing the number of parameters of a model of a deep neural network (DNN) using a sparsity regularized factorized matrix according to an embodiment of the present invention.

FIG. 4 is a flowchart showing a method of reducing the number of parameters of a model of a DNN using a sparsity regularized factorized matrix according to an embodiment of the present invention.

### DETAILED DESCRIPTION OF EXEMPLARY EMBODIMENTS

Hereinafter, the above and other objectives, advantages and features of the present invention and manners of achieving them will become readily apparent with reference to descriptions of the following detailed embodiments when considered in conjunction with the accompanying drawings

However, the present invention is not limited to such embodiments and may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing the embodiments of the present invention, a background for proposing the present invention will be described for the sake of understanding of those skilled in the art, and then the embodiments of the present invention will be described.

Deep learning is defined as a class of machine learning algorithms that attempt a high-level abstraction (a task of summarizing a core content or function from mass data or complex data) through a combination of several nonlinear transformations.

A deep neural network (DNN) is an artificial neural network (ANN) including multiple hidden layers between an input layer and an output layer.

The DNN may model complex non-linear relationships as in general ANNs.

For example, in a DNN architecture for an object identification model, each object may be represented to have a hierarchical configuration of basic elements of an image.

In this case, additional layers may compose features of lower layers that are progressively gathered.

Such characteristics of DNNs enable modeling of complex data only using fewer units or nodes than similarly performing ANNs.

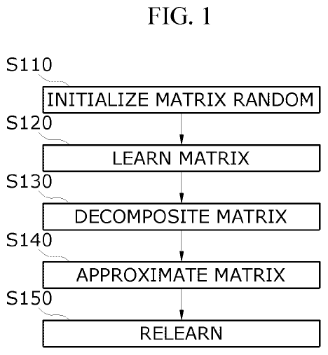

FIG. 1 is a flowchart showing a method using a low dimensional matrix decomposition according to related art.

Referring to FIG. 1, the method according to the related art includes matrix random initialization (S110), matrix learning (S120), matrix decomposition (S130), matrix approximation (S140), and relearning (S150).

According to the related art, each hidden layer of a DNN performs an affine transform on an input signal x using an augmented matrix W and obtains an output signal y through a nonlinear function σ( ) as shown in Equation 1 below.

y=σ(Wx) [Equation 1]

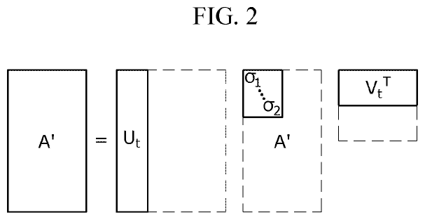

Accordingly, the most common way of reducing the number of model parameters of a DNN is to represent an approximate matrix Wₖ having been subjected to a low rank-k approximation with respect to the rank of a matrix using a low-dimensional matrix decomposition method as in a truncated singular value decomposition (TSVD) shown in FIG. 2.

According to the related art, a matrix W shown in Equation 1 is subject to matrix decomposition using a singular value decomposition (SVD) as shown in Equation 2.

y=σ(UΣV^{T}x) [Equation 2]

Singular value decomposition is a method of diagonalizing a matrix as in eigen decomposition, which is useful for all matrices regardless of whether the matrix is a square matrix or not.

In this case, Σ refers to a diagonal matrix including singular values that are diagonal elements.

Σ=diag(σ₁, σ₂, . . . , σₙ) σ₁≥σ₂≥ . . . σᵣ≥σᵣ₊₁= . . . σₙ=0 [Equation 3]

The square root of σ₁≥σ₂≥ . . . σᵣ≥σᵣ₊₁=0 provides singular values, and approximation is achieved by omitting ranks corresponding to lowest k-n singular values as show in Equation 4.

y≠σ(UₖΣₖVₖ^{T}x) [Equation 4]

However, such a TSVD-based model parameter reduction method according to the related art requires model retraining.

That is, according to the related art, the low-rank approximation leads to performance degradation, and in order to alleviate the performance degradation, a model retraining process is generally performed.

In addition, according to the related art, it is difficult to optimally determine the degree to which the rank is reduced for each hidden layer, and therefore an empirical and arbitrary fixed value needs to be used.

The present invention has been proposed to remove the above-described limitations and, in order to omit the retraining process and provide optimum rank reduction for each hidden layer, provides an apparatus and method for reducing the number of DNN model parameters using a sparsity regularized factorized matrix method.

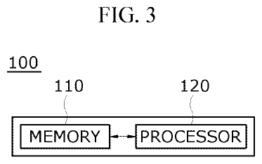

FIG. 3 is a diagram illustrating an apparatus for reducing the number of parameters of a model of a DNN using a sparsity regularized factorized matrix according to an embodiment of the present invention.

The apparatus for reducing the number of parameters of the model of the DNN using sparsity regularized factorized matrix according to the embodiment of the present invention includes a memory 110 in which a program for DNN model parameter reduction is stored and a processor 120 configured to execute the program, wherein the processor 120 represents a hidden layer using a full-rank decomposed matrix, uses training that is employed with a sparsity constraint for converting a diagonal matrix value to zero, and determines the rank of each hidden layer of the model of the DNN according to the degree of the sparsity constraint.

The processor 120 according to the embodiment of the present invention uses an error backpropagation-based training to perform the training employed with the sparsity constraint.

The processor 120 according to the embodiment of the present invention determines the rank of each hidden layer according to a value E that determines the degree of sparsity, and determines the number of reduced parameters of the model of the DNN according to the magnitude of the value of E using a sparsity regularization function.

The processor 120 according to the embodiment of the present invention represents an approximate matrix in which the rank of the matrix is approximated to a low rank according to a result of learning.

The above-described conventional TSVD based low-rank approximation method according to the related art has an effect of forcibly assigning zero to a value close to zero among values of a diagonal matrix Σ for the full-rank matrix as shown in Equation 5 below.

UₖΣₖVₖ^{T}=UΣ*ₖVΣ*ₖ=diag(σ₁, σ₂, . . . , σₖ, 0, . . . ) [Equation 5]

In other words, the low-rank approximation method may be regarded as a problem that sends the diagonal matrix values into zero as much as possible, that is, a sparsity regularization problem.

According to the embodiment of the present invention, in order to eliminate the retraining process, the hidden layer is represented using a full-rank decomposed matrix from the beginning, as shown in Equation 6 below.

y=σ(UΣV^{T}x) [Equation 6]

In addition, according to the embodiment of the present invention, when the training is performed, an error backpropagation-based training that is employed with a sparsity constraint for converting the diagonal matrix value to zero as shown in Equation 7 below is used.

```
Algorithm 1 SPGD for Sparsity constraint
Require: A training set S, initial values w⁰ and y⁰
  1: while not converged do
  2: Select a training point (i,j) ϵ Z at random
  3: u^{k+1} ← u^{k} − η∇ᵤ [symbol]   (θ)
  4: v^{k+1} ← v^{k} − η∇ᵥ [symbol]   (θ)
  5: Σ^{k+1} ← Σ^{k} − η∇_{Σ} [symbol]   (θ)
  6: Σ^{k+1} ← T(Σ^{k+1},ϵ)
  7: end while
```

In this case, a T( ) function is expressed as shown in Equation 8 below.

$$T ( x , ϵ ) = \{ \begin{matrix}0 , & if x \leq ϵ \\ x , & otherwise\end{matrix} \qquad [ Equation 8 ]$$

According to the embodiment of the present invention, an individual rank for approximation of each hidden layer is not determined, and the rank of each hidden layer is determined by a value of ϵ.

The value of ϵ determines the degree of sparsity. A larger ϵ provides a greater sparsity so that the number of reduced parameters is increased.

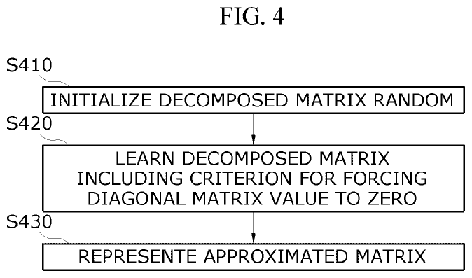

FIG. 4 is a flowchart showing a method of reducing the number of parameters of a model of a DNN using a sparsity regularized factorized matrix according to an embodiment of the present invention.

The method of reducing the number of parameters of the model of the DNN using sparsity regularized factorized matrix according to the embodiment of the present invention includes representing hidden layers of a model of a DNN using a full-rank decomposed matrix (S410, a decomposed matrix random initialization) and using training to convert a diagonal matrix value to zero (S420, a decomposed matrix learning including a criterion for forcing a diagonal matrix value to zero).

In this case, operation S420 includes determining the rank of each hidden layer of the model of the DNN according to the degree of a sparsity constraint.

Operation S420 includes using error backpropagation-based training that is employed with the sparsity constraint.

Operation S420 includes performing the training using the algorithm shown in Equation 7 as described above as an algorithm for the sparsity constraint.

Operation S420 includes determining the rank of each hidden layer according to a value ϵ that determines the degree of sparsity and determining the number of reduced parameters the model of the DNN according to the magnitude of the value ϵ using a sparsity regularization function T shown in Equation 8 as described above.

The method according to the embodiment of the present invention further includes representing an approximate matrix in which the rank of the matrix is approximated to a low rank according to a result of learning (S430, an approximate matrix representation).

Meanwhile, the method of reducing the number of model parameters of the DNN) using a sparsity regularized factorized matrix according to the embodiment of the present invention may be implemented in a computer system or may be recorded on a recoding medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Therefore, the method of reducing the number of model parameters of the DNN) using sparsity regularized factorized matrix according to the embodiment of the present invention may be implemented in the form executable by a computer. When the method of reducing the number of model parameters of the DNN) using sparsity regularized factorized matrix according to the embodiment of the present is performed by the computer device, instructions readable by the computer may perform the method of reducing the number of model parameters of the DNN) using sparsity regularized factorized matrix according to the embodiment of the present invention.

Meanwhile, the method of reducing the number of model parameters of the DNN) using sparsity regularized factorized matrix according to the embodiment of the present invention may be embodied as computer readable codes on a computer-readable recording medium. The computer-readable recording medium is any data storage device that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, the number of model parameters in a DNN-based model is reduced using a sparsity regularized factorized matrix method, thereby obviating the need for model-retraining required for preventing the performance degradation from occurring at a time of low-rank approximation according to the related art and omitting the retraining process.

The effects of the present invention are not limited to the above description, and the other effects that are not described may be clearly understood by those skilled in the art from the detailed description.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. An apparatus for reducing parameters of a model of a deep neural network (DNN) using a sparsity regularized factorized matrix, the apparatus comprising:
a memory in which a program for DNN model parameter reduction is stored; and
a processor configured to execute the program,
wherein the processor represents hidden layers of the model of the DNN using a full-rank decomposed matrix, uses training that is employed with a sparsity constraint for converting a diagonal matrix value to zero, and determines a rank of each of the hidden layers of the model of the DNN according to a degree of the sparsity constraint.

2. The apparatus of claim 1, wherein the processor uses an error backpropagation-based training to perform the training employed with the sparsity constraint.

3. The apparatus of claim 1, wherein the processor determines the rank of each of the hidden layers according to a value of ϵ that determines a degree of sparsity.

4. The apparatus of claim 3, wherein the processor determines a number of reduced parameters of the model of the DNN according to a magnitude of the value ϵ using a sparsity regularization function.

5. The apparatus of claim 1, wherein the processor represents a matrix in which the rank of the matrix is approximated to a low rank according to a result of learning.

6. A method of reducing parameters of a model of a deep neural network (DNN) using a sparsity regularized factorized matrix, the method comprising:
(a) representing hidden layers of the model of the DNN using a full-rank decomposed matrix;
(b) using training that is employed with a sparsity constraint for converting a diagonal matrix value to zero; and
(c) determining a rank of each of the hidden layers of the model of the DNN according to a degree of the sparsity constraint.

7. The method of claim 6, wherein step (b) comprises using an error backpropagation-based training that is employed with the sparsity constraint.

8. The method of claim 7, wherein step (b) comprises performing training according to an algorithm for the sparsity constraint:
```
Require: A training set S, initial values w⁰ and y⁰
  1: while not converged do
  2: Select a training point (i, j) ∈ Z at random
  3: u^{k+1} ← u^{k} − η∇ᵤ [symbol] (θ)
  4: v^{k+1} ← v^{k} − η∇ᵥ [symbol] (θ)
  5: Σ^{k+1} ← Σ^{k} − η∇_{Σ} [symbol] (θ)
  6: Σ^{k+1} ← T(Σ^{k+1}, ϵ)
  7: end while
```

9. The method of claim 6, wherein step (c) comprises determining the rank of each of the hidden layers according to a value of ϵ that determines a degree of sparsity.

10. The method of claim 9, wherein step (c) comprises determining a number of reduced parameters of the model of the DNN according to a magnitude of the value ϵ using a sparsity regularization function T in Equation:
$$T ( x , ϵ ) = \{ \begin{matrix}0 , & if x \leq ϵ \\ x , & otherwise\end{matrix} . \qquad [ Equation ]$$

11. The method of claim 6, further comprising (d) representing a matrix in which the rank of the matrix is approximated to a low rank according to a result of learning.
